(19) United States
(12) Patent Application Publication
(10) Pub. No.: US 2007/0075912 A1
(43) Pub. Date: Apr. 5, 2007

(54) Device for receiving and releasing free forms of energy by radiation

(76) Inventor: Gunther Schwarzer, Fassangasse (AT)

Correspondence Address: RATNERPRESTIA, P O BOX 980, VALLEY FORGE, PA, 19482-0980, US

(21) Appl. No.: 10/552,093

(22) PCT Filed: Apr. 1, 2004
(86) PCT No.: PCT/AT04/00114

§ 371 Date: Jun. 7, 2006

(30) Foreign Application Priority Data
Apr. 4, 2003 (AT) A 530/2003

(51) Int. Cl. H01Q 1/36

(52) U.S. Cl. 343/895; 343/893

(57) ABSTRACT

The invention relates to a device for receiving and releasing free forms of energy by radiation, said device comprising a number of antenna elements arranged about a common axis and respectively comprising an electrical conductor, especially an electrical conductor extending in a spiral-type manner about an axis and/or an electrical conductor consisting of interconnected closed geometrical figures. The antenna elements are divided between at least two groups provided on different parallel planes namely, a first group comprising at least three antenna elements that are adjacently arranged in a distributed manner, namely around at least one imaginary circle about a group axis, and a second group. Each antenna element of the first group is electrically connected to an associated antenna element of a second group.

The present invention pertains to a device for receiving and releasing free forms of energy by radiation, comprising a number of antenna elements arranged about a common axis with an electrical conductor each, especially an electrical conductor running in a spiral-like manner about an axis and/or an electrical conductor consisting of interconnected, closed geometric figures, whereby the antenna elements are divided between at least two groups provided on different parallel planes.

Devices of this type are used for generating various effects, whose mode of action is admittedly not (yet) scientifically understood; even so, a positive effect has been confirmed again and again. E.g., the dehumidification of masonry or (conversely) increasing the soil moisture, damping of the effect of geopathogenic interference fields or interference zones, the treatment/programming of water, as well as the harmonization of negative force fields (e.g., electrosmog) are possible applications in this case.

A device of the type described emerges from EP 0 688 383 B1. This document discloses a device for the conveying of moisture or salts, consisting of a plurality of plates, on whose top side and/or bottom side are located an electrical conductor wound into a coil each. The coils may be designed as multispirals, in which a plurality of lines originate from the same center and are wound about same. This has the drawback that, even if only one of these spirals is disturbed or does not operate properly, the entire multispiral is compromised. The device is thus very unstable. When using a plurality of devices of this design, careful attention must, furthermore, be paid to providing sufficient distance between devices, since feedbacks develop very easily, whereby the devices put one another out of operation.

A device for dehumidifying masonry, which comprises two electrical conductors (e.g., consisting of copper wire), each wound into a coil having a plurality of windings, each of which is connected at both of its ends to the two poles of a condenser, whereby the longitudinal axes of the condensers are aligned in respect to the magnetic field of the earth, is described in AT 379 183 B. AT 380 047 B, AT 382 915 B and AT 397 681 B, in which one, two or three conductors wound into a coil are combined with at least one antenna—e.g., a telescopic antenna—provided at the end of a conductor, are based on a similar concept.

EP 0 152 510 A1 discloses a device for the dehumidification of masonry which has condensers and electrical conductors wound into coils, whereby one condenser and one coil each are connected to an oscillating circuit closable by means of a switch; two such oscillating circuits are provided with a different number of windings and a different external diameter in a housing made of an electrically nonconductive material.

However, the production of these coil arrays is expensive and requires, moreover, the use of electronic components, such as condensers or the like.

A pyramid energy plant, in which is provided a conductor guided about a pyramid on the outside in a spiral-like manner, is described in EP 0 259 769 A1; the conductor may be an unshielded electric cable or a tubular body, through which is sent a liquid, such as, e.g., water, juices or fuel, or a gas. According to this document, this plant is suitable for absorbing “pyramid energy” via the electric cable or for reducing the radioactive load of a liquid passing through the tubular body. However, this device is not suitable for use for diverting free forms of energy.

The object of the present invention is to overcome the above-mentioned drawbacks of the prior-art devices.

The object is accomplished by a device of the type mentioned in the introduction, in which a first group of antenna elements according to the present invention has at least three antenna elements, which are arranged adjacent to one another, namely, distributed around at least one imaginary circle about a group axis, and each antenna element of the first group is electrically connected to an antenna element of a second group associated therewith.

The arrangement of the antenna elements in two groups, whereby the individual elements in a group lie adjacent to one another, instead of “inserted” into one another as in EP 0 688 383 B1, results in a markedly improved action of the entire device. In this case, the antenna elements of one group shall be used for receiving and those of the other group for releasing free energies by radiation. According to the present invention, one receiving antenna element each is connected to a sending antenna element, while the remaining receiving antenna elements (and thus also the sending antenna elements associated therewith) operate in an electrically independent manner. Thus, the electrically interconnected elements form subdevices that operate each independently from the other subdevices respectively.

The present invention results in considerable advantages over the other prior-art devices mentioned above:
increase in performance, partly as a result of the larger number of antenna elements, partly due to the special type of electrical connection,
smaller dimensions with same efficiency,
controllable level of performance, to be precise without exertion of influence on the position of the device or the position height,
directional characteristic adjustable by means of suitable occupation or omission of antenna elements or subdevices,
consideration of ferromagnetic interference effects on the design of the device,
possibility of setting up a plurality of devices without adhering to a minimum distance by means of suitable coordination (directional characteristic) of the devices with one another.

Moreover, compared to EP 0 688 383 Bl, which suggests a multispiral antenna with a common center, a symmetrical alignment of the individual single spirals (or antenna elements) is omitted here, since each antenna element acts independently of those of the same group according to the present invention.

The present invention can be used for various purposes. The damping of ground radiation, release of biologically beneficial frequencies by radiation, energizing of water, foods, fuels, etc., as well as not least applications for masonry dewatering or ground humidification may especially be mentioned in this respect. For this purpose, the device according to the present invention acts on various geodynamic spectra that are present in an area-covering pattern to varying extent and manifestation. The spectra or fields are absorbed by the device, set in the desired resonance depending on use and then released again.

In an advantageous embodiment of the present invention, at least some of the antenna elements—preferably those that are used as receiving elements—have a spiral-like electrical conductor running about an axis each. Due to the spiral shape, a favorable magnetic wave shape and amplitude can be produced.

In this case at least some of the antenna elements can be designed as flat lines, each of which runs in a spiral-like manner about a center, whereby the electrical connection is made at the end of the line near the center. The flat lines may be composed, e.g., of straight line segments which are often repeatedly offset by an angle, whereby the scale of the dimensions of these line segments gradually changes with the uniformly increasing distance from the center and all in all they form a continuous line. This permits an easy creation of the geometric shape that displays an action that is just as good as, e.g., a geometric spiral.

In addition, at least some of the antenna elements may be shaped according to a spiral line running about a cone-shaped shell. Horizontal energy fields—e.g., Curry or Hartmann lines—can also be absorbed or damped with a three-dimensional spiral.

Likewise, in order to be able to couple into different geodynamic frequencies beyond the so-called hydrogen frequencies, it may be advantageous if at least some of the antenna elements comprise an electrical conductor consisting of interconnected, closed geometric figures each.

In this case, it is expedient if the geometric figures in the antenna elements have a similar shape, but become smaller and smaller towards the center. This produces an improved concentration of the collected or distributed energy.

Furthermore, it is favorable if the antenna elements of the first and second groups are arranged in pairs congruent to one another—optionally with a reverse orientation—in the different group planes. This permits the conversion of the treated frequencies into desired polarizations. For example, the sending antenna elements are designed as right-polarized in the application for masonry dewatering, since—according to results obtained for many years—a water motion is affected the right-polarized waves thus produced in such a way that this is deflected downwards.

The antenna elements of the first and second groups may be arranged about a common group axis and may each be oriented offset against an adjacent element of the same group by an angle, which corresponds to the offset angle about the group axis. As a result, the antenna elements may provide for various areas about the device according to the present invention independently from each other, without obstructing one another in the mode of operation. It is additionally advantageous here if the antenna elements of the first and second groups are arranged offset in relation to one another about a common group axis by equal angular distances and at a constant distance to the group axis.

In a preferred embodiment of the present invention, the first and second groups are arranged on different plates parallel to one another, and the electrical connection of the antenna elements of both groups corresponding to one another is made by means of electrically conductive connection pieces, which at the same time mechanically stabilize the plates in relation to one another. This makes possible the absorption of the widest variety of geodynamic frequencies, from which the desired frequencies to be released are filtered.

To also absorb or damp horizontal energy fields, e.g., Curry lines or Hartmann lines, the connection pieces may additionally be shaped at least partly as a spiral line running around a cone-shaped shell.

In another preferred embodiment that can absorb energies both in a left- and right-polarized manner and filter desired release frequencies from these energies, the first group is arranged on one side of a plate, on the opposite side of which is arranged a third (different from the first and second groups) group of antenna elements, which are electrically connected to the respective, corresponding antenna elements of the first group.

In order to make possible the absorption of forms of energy of both possible polarities, the antenna elements of the third group may have a direction of winding which is opposite that of the antenna element of the first group.

The number of antenna elements in a group is advantageously even-numbered, and particularly four or eight.

A housing that is electrically separated from the antenna elements is expedient for shielding against electrosmog or other adverse effects. The housing preferably has a concave top side and bottom side.

The present invention together with other advantages is described below on the basis of nonlimiting exemplary embodiments, namely, variants of a device for masonry dewatering, which are shown in the attached drawings. In the drawings,

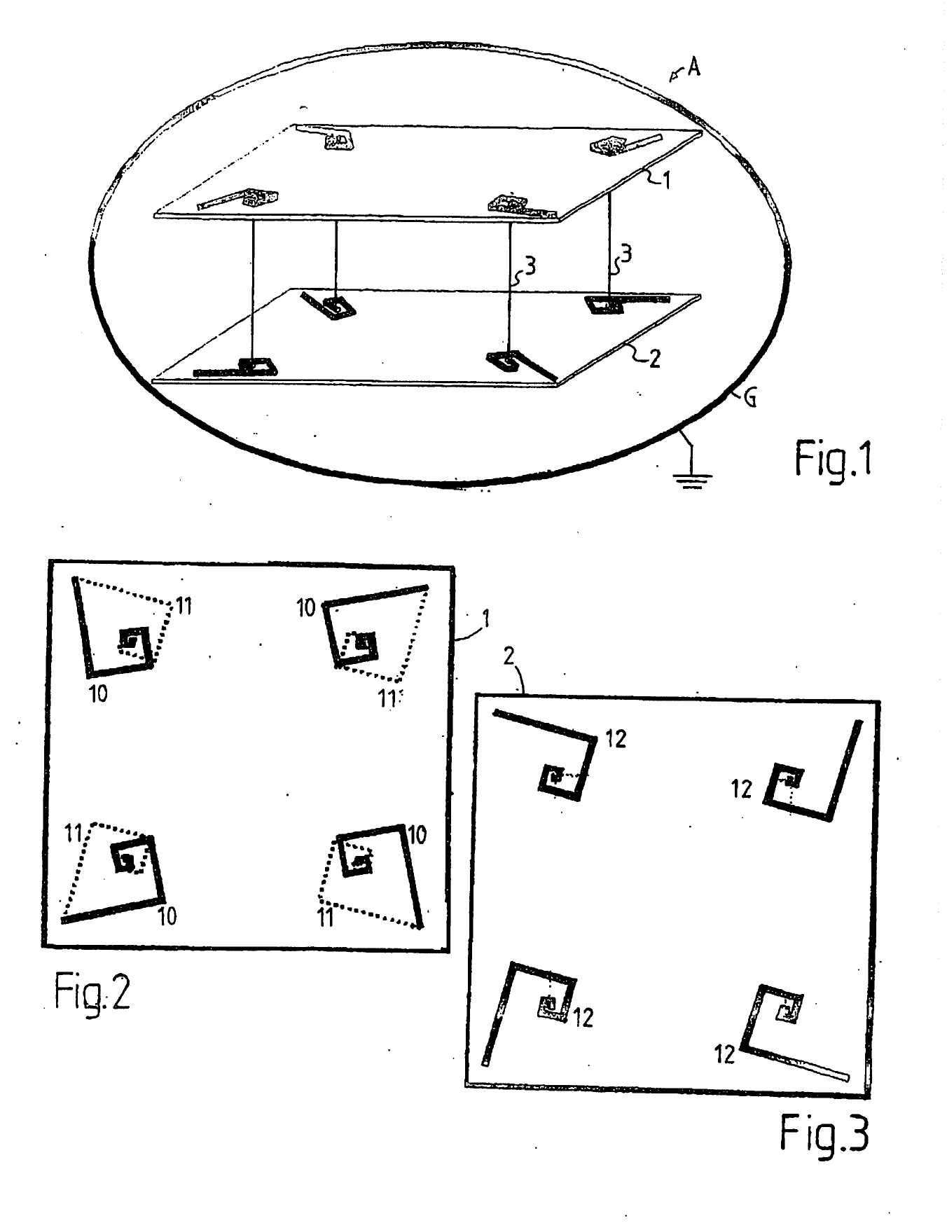

FIG. 1 shows a first exemplary embodiment with spiral-like antenna elements;

FIG. 2 shows the receiving antennas of the device of FIG. 1;

FIG. 3 shows the sending antennas of the device of FIG. 1;

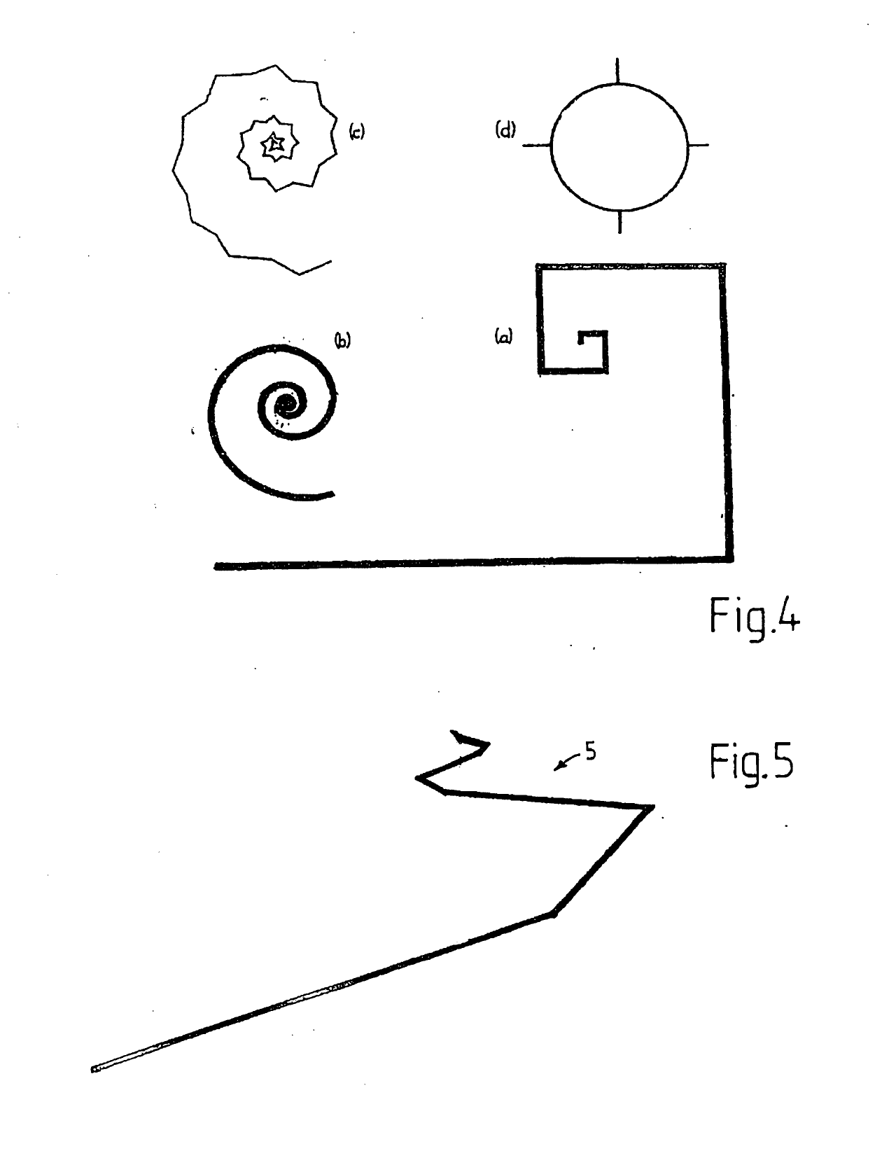

FIG. 4 shows a few suitable variants of the shape of the antenna elements;

FIG. 5 shows a front view of a three-dimensional antenna element;

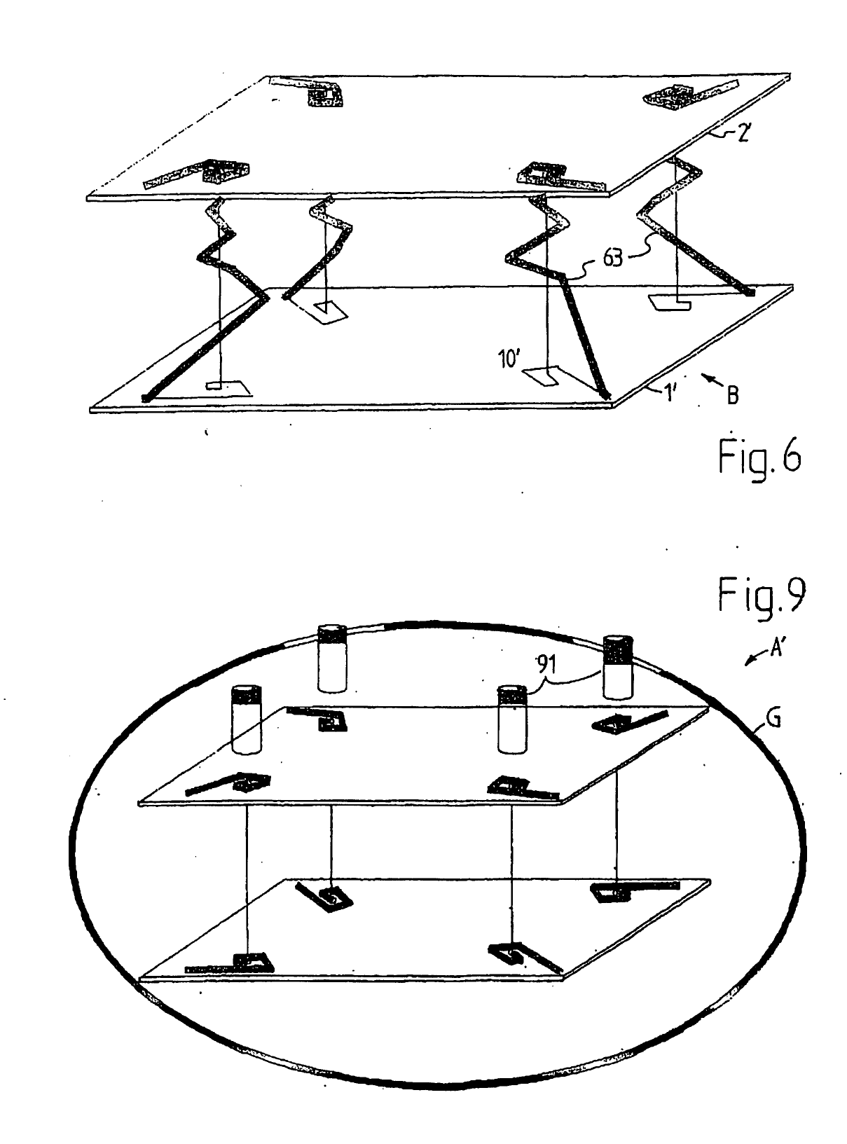

FIG. 6 shows a secondary exemplary embodiment;

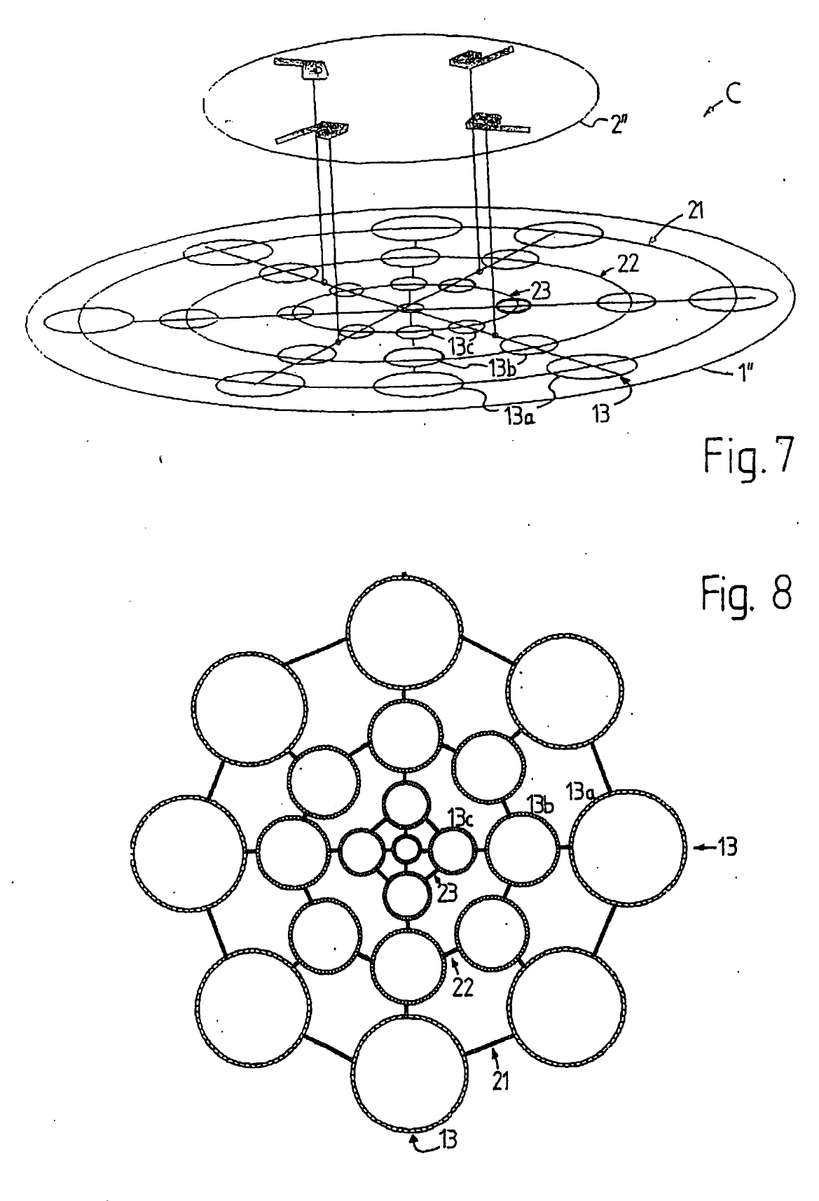

FIGS. 7 and 8 show a third exemplary embodiment with antenna elements consisting of circular elements; and

FIG. 9 shows the use of a device according to the present invention for energizing liquids or crystals.

FIG. 1 shows a device A according to the present invention, which is especially used for masonry dewatering, in an oblique view laterally from above. The device A consists of two plates 1 and 2 arranged one above the other, which are connected by means of a plurality of connection pieces 3. The connection pieces 3 are at the same time used for the mechanically stable arrangement of the plates 1 and 2 in relation to one another and for the electrical connection of the antenna elements provided there (FIGS. 2 and 3). In the example being considered, the plates 1, 2 have a square design and are electronic printed circuit boards having the size 20 cm×20 cm; the connection pieces 3 are designed as non-insulated copper wires with a conductor cross section of 1.5 mm² and a length of 7 cm.

FIG. 2 shows a top view of the lower plate 1 of the device A. The plate 1 is used as a receiving antenna means and has a number of antenna elements 10, 11, to be precise, each group of four antenna elements occupies the top side (elements 10) and the bottom side (elements 11, shown as dash-lined in FIG. 2). The antenna elements 10, 11 are geometric elements in the form of right-angled, decreasing lines. The elements 10 located on the top side have the same direction of winding, which is, however, opposite that of the antenna elements 11 located on the bottom side.

FIG. 3 shows a top view of the upper plate 2 which is used as a sending antenna means. The plate 2 has only one array of antenna elements 12, namely, on the top side, whereby its antenna elements 12 are oriented opposite to the direction of winding of the corresponding elements 10 of the top side of the receiving antenna means.

In the exemplary embodiment shown, the antenna elements 10, 11, 12 are embodied as tin-plated copper strip conductors that are produced by means of a common industrial printed circuit board etching process. The antenna elements 10, 11, 12 have the same geometric shape, which is also shown in FIG. 4a on an enlarged scale; in other embodiments of the present invention, they may be shaped differently from one another as well. Even though the positioning of the antenna elements within a group does not generally need to be symmetrical, it is favorable if their positions correspond to the points of a regular polygon, such that they are arranged about a center each rotationally offset by a constant angle. In this case, the angle is to be selected corresponding to the number of elements in a group, namely, 120° in case of three elements, 90° in case of four elements, etc., and 360°/n in case of n elements (n≧3). The antenna elements 10, 11, 12 are in this way rotated by this angle, such that a uniform absorption or release by radiation is achieved on the entire circumference of the device A.

The two plates 1 and 2 are connected by means of a number of wire pieces 3 corresponding to the number of antenna elements—thus four in the exemplary embodiment being shown—via soldered joints, which create an electrical connection to the antenna element on its inner end. For this, the plates 1, 2 are provided at the positions of the ends of the wire pieces 3 with holes corresponding to the wire gauge for absorption and feedthrough.

On the other hand, there is no electrical connection between adjacent antenna elements. Each of the antenna elements 10 thus forms, together with the antenna element 11 lying opposite it on the same plate 1 and the antenna element 12 on the plate 2 associated therewith, a subdevice, which is, as it were, responsible for a sector of the surroundings of the entire device A. The device A comprises four such subdevices, which are electrically independent of one another.

In each subdevice, the energy forms received and concentrated via the receiving antenna elements 10, 11 are guided via the respective connection piece 3 upwards to the associated sending antenna element 12 and then released by radiation again from this. In this case, the distance between the sending antenna and the receiving antenna has an effect on the transmitting power, to be precise, the greater the distance, the higher is the transmitting power. The antenna elements, both those of the receiving antenna means and of the sending antenna means as well as the connection between them may consist of the widest variety of electrically conductive materials.

There is an advantageous effect on the operation of the device A if it is accommodated in a housing G (shown in a cut-away view in FIG. 1), which is electrically conductive and is well grounded via a ground connection. This is used for shielding the device against electrosmog or electrical booster charge that is present, which could compromise the mode of action of the device. The housing G has preferably a concave top side and bottom side. In the example shown in FIG. 1, the housing G is shaped as an ellipsoid-like shell coated with an electrical conductor. There is no electrical connection between the housing G and the antenna elements 10, 11, 12 of the device A.

If necessary, a directional characteristic may also be provided in a device according to the present invention, e.g., by means of nonoccupation of a space for an antenna element.

FIG. 4 shows various examples of possible shapes of antenna elements. Besides the shape shown in FIG. 4a, which is used in the exemplary embodiment of FIGS. 1-3, FIGS. 4b and 4c show other shapes, which correspond to a spiral, and FIG. 4d shows an exemplary closed shape.

The geometric shape may especially follow a logarithmic spiral, as shown in FIG. 4b, or be a line consisting of straight segments lined up next to one another, as shown in FIGS. 4a and 4c. The shape according to FIG. 4c starts from a basic line in the form of a V-like angle, which is often repeatedly offset by an angle, whereby the scale of the dimensions of the repeating line gradually changes with the uniformly increasing distance from the center and the start of the next line is added at the end of a line. Thus, a continuous line is formed, which imitates a “spiral” running about the center of the shape. The shape according to FIG. 4a may also be obtained in such a way, e.g., if a straight section is taken as the basic line, which is repeatedly added offset by an angle of 90° by a constant factor of greater than 1.

The spirals according to FIG. 4 advantageously decrease from outside inwardly per rotation by a factor of 67-92%.

The antenna elements may be embodied as flat figures or even in a three-dimensional shape. FIG. 5 shows a top view of a three-dimensional shape of an antenna element 5, in which the cross section corresponds to FIG. 4a. Thus, this corresponds to a “three-dimensional spiral” running on an imaginary cone-shaped or pyramid shell, which is wound about the cone or pyramid axis. Three-dimensional antenna elements of this type may be made, for example, of bent copper wire. Such antenna elements 5 may replace, e.g., the antenna elements 10, 11, 12 and/or the conductor pieces 3.

FIG. 6 shows another exemplary embodiment B, in which three-dimensional antenna elements of this type are used as connection pieces 63 in a device according to the present invention. In this case, the outer tip of each three-dimensional spiral 63 is in contact with the plate 1′ at the position of the outer tip of the corresponding antenna element 10′; the tip of the three-dimensional spiral 63 is in contact with the plate 2′ and thus produces the electrical contact there.

Another embodiment variant C of the present invention is shown in FIGS. 7 and 8. The antenna elements 13 on the receiving side are embodied as a sequence of circular elements 13a, 13b, 13c here. These are in turn arranged in concentric circles 21, 22, 23, whereby the individual elements 13a, 13b, 13c become smaller and smaller towards the center in order to produce a dynamics in this way, which results in the mode of operation of the device. Inwardly, each of the elements decreases by a factor of 32% to 94%.

Instead of the circular shape of the elements 13a, 13b, 13c, other closed figures, such as rectangles, squares, ellipses, trapezoids, etc. may also be used. A three-dimensional arrangement, e.g., of spherical elements around a circular cone is also possible, whereby the spherical elements are interconnected along a parabola around the cone-shaped shell.

For the application of the device according to the present invention for masonry dewatering—in the capillary system of the masonry, rising soil moisture shall be stopped and moved back downwards—the device is mounted within or outside of the building, taking the maximum area of action and the masonry penetration into consideration. In large buildings, the mounting of two or more devices may also be necessary. The dehumidification takes place by means of the release of a field repolarizing the water molecules via the sending antenna elements. In this case, the type of the polarization is determined by the direction of winding of the sending antenna elements, and to be precise, the sending antenna element must be right-wound, as viewed in the running direction from sending element to receiving element. For the area of action, it is possible to assume a maximum radius of 9 m, with a penetration of solids of 3 m, for a device such as the device A described here.

For the soil humidification, the process is as in masonry dewatering, but with the opposite direction of winding of the sending antennas, so that a reverse polarized field is released by radiation in this case.

For the damping of earth's radiation, a device according to the present invention is mounted next to the space loaded with geopathogens. The device draws in the interfering fields from below by means of the receiving antenna elements and converts these into positive waves of the opposite direction of rotation, which are released by the sending antenna elements as an opposing field. The field size can be adjusted by means of the mounting space and the directional characteristic (of the antenna elements used) of the device. If necessary, the device can be adapted to the desired ground plan to be shielded by deactivating individual sending antenna elements.

In addition to the above-described applications for dewatering or soil humidification, the present invention may also be used for releasing biologically beneficial frequencies by radiation. This is shown in an example in FIG. 9. Ampoules 91, which are filled with homeopathic dilutions, Bach Flowers, are arranged above, below or within a device according to the present invention—here, e.g., corresponding to the first exemplary embodiment A—; for example, the ampoules are positioned directly above the sending elements. Instead of the ampoules 91, precious stones may also be used as carrier substances for biologically effective frequencies. In this way the information of the substances or precious stones can be distributed over a larger spatial area. The device may be adapted to the size and ground plan of the accommodations to be radiated in the manner already described above. Moreover, it is possible by means of using various carrier substances to bombard the various radiation segments with different frequencies.

1. A device for receiving and releasing free forms of energy by radiation, comprising a number of antenna elements arranged about a common axis with an electrical conductor each, whereby the antenna elements are divided between at least two groups provided on different parallel planes,
a first group has at least three said antenna elements, which are arranged adjacent to one another in a distributed manner, namely, around at least one imaginary circle about a group axis, and each antenna element of the first group is electrically connected to an antenna element of a second group associated therewith.

2. The device in accordance with claim 1, wherein at least some of the antenna elements each have an electrical conductor running in a spiral-like manner about a respective axis.

3. The device in accordance with claim 2, wherein at least some of the antenna elements are designed as flat lines, which run in a spiral-like manner about a center of each antenna element, whereby an electrical connection is made at the end of each line near the center.

4. The device in accordance with claim 3, wherein the flat lines are composed of straight line segments, which are repeatedly offset by an angle, whereby the scale of the dimensions of these line segments gradually changes with a uniformly increasing distance from the center and wherein the segments form a continuous line.

5. The device in accordance with one of the 4, charactcriecd in that claim 2 wherein at least some of the antenna elements are shaped according to a spiral line running around a cone-shaped shell.

6. The device in accordance with claim 1, wherein at least some of the antenna elements each have an electrical conductor consisting of interconnected, closed geometric figures.

7. The device in accordance with claim 6, wherein the geometric figures have a similar shape as the antenna elements, but become smaller and smaller towards a center of the geometric figures.

8. The device in accordance with claim 1, wherein the antenna elements of the first and second groups are arranged in pairs congruent to one another in the different planes.

9. The device in accordance with claim 8, wherein the antenna elements of the first and second groups are arranged about a common group axis and are each oriented offset against an adjacent element of the same group by an angle that corresponds to an offset angle about the group axis.

10. The device in accordance with claim 9, wherein the antenna elements of the first and second groups are arranged offset to one another about a common group axis by equal angular distances and at a constant distance to the group axis.

11. The device in accordance with claim 1, wherein the first and second groups are arranged on different plates that are parallel to one another, and the electrical connection of the antenna elements of both groups corresponding to one another is made by means of electrically conductive connection pieces, which at the same time mechanically stabilize the plates in relation to one another.

12. The device in accordance with claim 11, wherein the connection pieces are shaped at least partially as a spiral line running around a cone-shaped shell.

13. The device in accordance with claim 1, wherein the first group is arranged on one side of a plate, on the opposite side of which is arranged a third group, different from the first and second groups of antenna elements, which are electrically connected to the respective, corresponding antenna elements of the first group.

14. The device in accordance with claim 13, wherein the antenna elements of the third group have a direction of winding that is opposite that of the antenna elements of the first group.

15. The device in accordance with claim 1, wherein the number of antenna elements in a group is even-numbered, and particularly four or eight.

16. The device in accordance with claim 1, wherein a housing is electrically separated from the antenna elements.

17. The device in accordance with claim 16, wherein the housing has a concave top side and bottom side.
